(19) United States
(12) Patent Application Publication
(10) Pub. No.: US 2003/0016923 A1
(43) Pub. Date: Jan. 23, 2003

(54) Dispersion managed fiber optic cable system with bridging path and marking methods therefor

(76) Inventors: Timothy F. Summers, Hickory, NC (US); Michael S. Fedoroff, Saskatoon (CA)

Correspondence Address: CORNING CABLE SYSTEMS LLC, P O BOX 489, HICKORY, NC, 28603, US

(21) Appl. No.: 09/908,183

(22) Filed: Jul. 18, 2001

(51) Int. Cl. G02B 6/44; G02B 6/02

(52) U.S. Cl. 385/100; 385/123

(57) ABSTRACT

A fiber optic cable for use in a dispersion managed cable system, the cable including at least one bridging path having first and second optical fibers and a bridge optical fiber. The first and second optical fibers have predetermined chromatic dispersion characteristics such that the range of the absolute values of the chromatic dispersion of the optical fibers is about ten to about forty ps/nm.km. A mode field diameter differential exists between the first and second optical fibers. The bridge optical fiber is spliced to each of the first and second optical fibers thereby bridging the mode field diameter differential. The bridge optical fiber is spliced in defined splice areas. The fiber optic cable can include at least one marking generally indicating the location of the splice areas and/or bridge optical fiber.

The present invention relates to the field of fiber optic cables, and, more particularly, to fiber optic cables having at least one optical fiber with a chromatic dispersion characteristic. Fiber optic cables are used to transmit telephone, television, and computer data information in indoor and outdoor environments.

Chromatic dispersion can be viewed as the sum of material and waveguide dispersions. Changes in refractive index with wavelength give rise to material dispersion. In glass (silica) fibers, material dispersion increases with wavelength over a wavelength range of about 0.9 μm to 1.6 μm. Material dispersion can have a negative or a positive sign, the sign indicating whether the shorter or longer wavelengths travel faster in the optical fiber. The waveguide dispersion is also a function of wavelength. In addition, waveguide and material dispersion effects can be summed yielding an overall positive or negative chromatic dispersion characteristic in a given optical fiber.

A fiber optic cable design that incorporates chromatic dispersion affects is described in U.S. Pat. No. 5,611,016. The patent pertains to a dispersion-balanced optical cable for reducing four-photon mixing in Wave Division Multiplexing systems, the cable being designed to reduce cumulative dispersion substantially to zero. The dispersion-balanced optical cable requires positive and negative dispersion fibers in the same cable. Further, the positive dispersion aspect includes a dispersion defined as the average of the absolute magnitudes of the dispersions of the positive dispersion fibers exceeding 0.8 ps/nm.km at a source wavelength. In addition, the negative dispersion is defined as the average of the absolute magnitudes of the dispersions exceeding 0.8 ps/nm.km at the source wavelength.

The aforementioned optical fibers are single-mode fibers designed for the transmission of optical signals in the 1550 nm wavelength region. At defined parameters, the positive-dispersion is +2.3 ps/nm.km and the negative-dispersion is −1.6 ps/nm.km. Crossover connection hardware, disposed exteriorly of the cables, is required to interconnect the positive and negative fibers, preferably at mid span. Such crossover connections can be made within closures similar to the one shown in U.S. Pat. No. 5,481,639.

### ASPECTS OF THE INVENTIONS

In an aspect of the present invention a transition fiber optic cable is described for use in a DMCS. The cable includes at least one bridging path having, in optical communication, first and second optical fibers and a bridge optical fiber, a mode field diameter differential existing between the first and second optical fibers. The first and second optical fibers have predetermined chromatic dispersion characteristics such that the range of the absolute values of the chromatic dispersion of the optical fibers is about ten to about forty ps/nm.km. The bridge optical fiber is an integral part of the cable construction and is spliced to each of the first and second optical fibers thereby bridging the mode field diameter differential.

In another aspect of the present invention a transition fiber optic cable with bridge path marking or other structural features is described for use in a DMCS. The cable includes at least one bridging path having first and second optical fibers and a bridge optical fiber, the first and second optical fibers having predetermined chromatic dispersion characteristics such that the range of the absolute values of the chromatic dispersion of the first and second optical fibers is about ten to about forty ps/nm.km. The bridge optical fiber is spliced to each of the first and second optical fibers defining splice areas, and the cable comprises at least one marking generally indicating the location of one or more of the splice areas and/or bridge optical fiber.

### BRIEF DESCRIPTION OF THE DRAWING FIGURES

FIG. 1 is an isometric view of a transition fiber optic cable according to the present invention with a portion of the cable jacket removed for illustration purposes.

FIG. 2 is a cross sectional view of a bridging path according to the present invention.

### DETAILED DESCRIPTION OF THE INVENTION

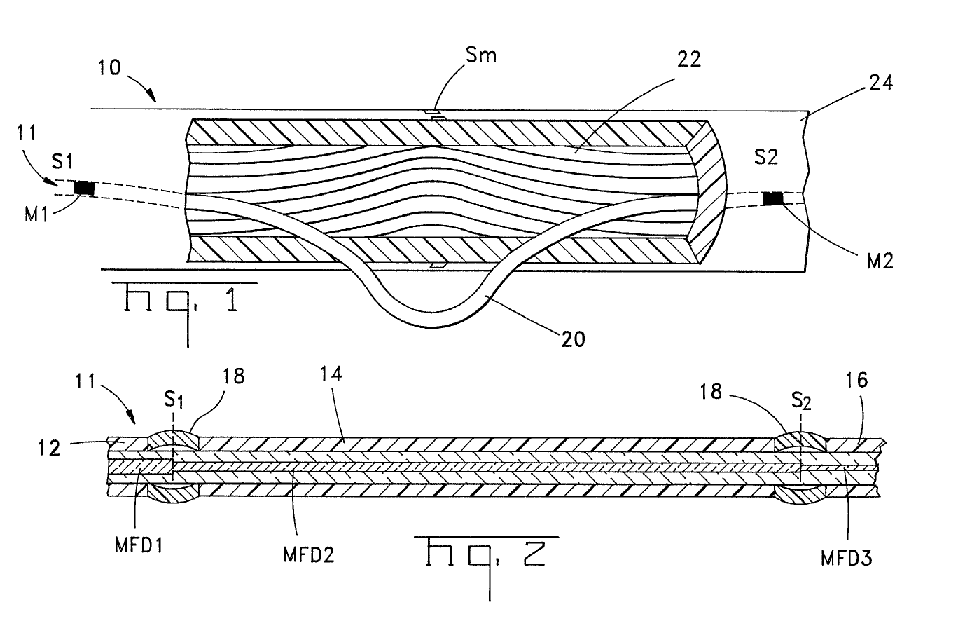

Referring to FIGS. 1-2, a transition fiber optic cable 10 for use in a dispersion managed cable system (DMCS) according to a first embodiment of the present invention will be described. Fiber optic cable 10 has at least two different optical fiber types having predetermined dispersion characteristics that are in optical communication with each other in a bridging path. Generally, the cables of the present invention include silica-based optical fibers, for example, that are made available by Corning Inc., and colored with UV curable inks. In accordance with the present inventions, at least some of the positive dispersion fibers have a chromatic dispersion of about positive ten to about positive thirty ps/nm.km. At least some of the negative dispersion fibers have a chromatic dispersion of about negative twenty to about negative forty ps/nm.km. In other words, the range of absolute values of the chromatic dispersion of at least some of the optical fibers in the DMCS of the present inventions is about ten to about forty ps/nm.km.

An aspect of the present invention resides in the cable including at least one bridging path 11, the bridging path including at least one positive dispersion optical fiber 12 spliced to a bridge optical fiber 14, that is in turn spliced to a negative dispersion optical fiber 16. Bridge optical fiber 14 is used to splice the dispersion fibers together. In accordance with the present invention, dispersion optical fibers 12 and 16 include significant differences in their respective effective areas or Mode Field Diameters (MFDs), defining a mode field diameter differential therebetween. Bridge fiber 14 optically bridges fibers 12 and 16 but is integrated in the cable as a fiber optic cable component. In one embodiment, the transition cable includes at least one bridging path 11. Portions of the bridging path include respective MFDs, so that the bridging path includes at least three MFDs therein. To illustrate, with reference to the exemplary embodiment of FIG. 2, bridging path 11 comprises MFD1, MFD2, and MFD3, such that MFD1>MFD2>MFD3. In addition, the cable can be constructed to sequentially include MFD3<MFD2<MFD1 in an bridging path for transmitting data in an opposing direction. In accordance with the present inventions, the MFD of a section of bridging path 11 can vary gradually or in a step along the length of fibers 12 and 16, and within bridge fiber 14.

In accordance with the present invention, fiber optic cable 10 can include integral, distinct bridging paths transmitting in a single direction or in more than one direction with the need for hardware. Bridging path 11 according to the present invention permits longer continuous installed cable lengths, facilitates optical measurements, and reduces installation costs, for example, eliminating cross-over connections and closures.

In accordance with other aspects of the present inventions, bridging path 11 includes at least two exemplary splice areas S1 and S2 (FIGS. 1-2). The splice areas are separated by a fraction of a meter to several meters in cable length. In an exemplary manufacturing method, a coating, typically UV curable, is removed from ends of fibers 12, 14, and 16. Optical fiber 12 is spliced, preferably by a fusion splicing process, to bridge fiber 14 defining splice area S1, and optical fiber 16 is likewise spliced to bridge fiber 14 by a fusion splicing process defining splice area S2. Next, coatings 18, preferably a UV curable coating that is compatible with the pre-existing fiber coatings, is applied over splice areas S1 and S2. Coatings 18 are then cured in a way that secure bonding occurs between the coatings, and the splices are mechanically and environmentally protected. For an exemplary purpose of defining splice area markings, coatings 18 can be the same color, distinct colors, or non-colored.

In another aspect of the present inventions, transition cable 10 includes markings indicating the general location of splice areas S1 and S2 (FIG. 1). Markings S1 and S2 can be made in accordance with an exemplary manufacturing process according to an aspect of the present invention. First, bridging path 11 includes coatings 18 comprising a pigment colored band or other suitable marking feature that can be read by a sensor. Suitable reading and marking processes are disclosed in U.S. Pat. Nos. 5,729,966 and 5,904,037, and pending U.S. Ser. Nos. 09/220,121 and 09/220,158, which disclosures are incorporated herein by reference in their respective entireties. Bridging path 11 is then fed through a buffering line, alone or with other optical fibers or cable components. As bridging path 11 is paid off, a marking system reads the location of splice S1 and/or S2 and coatings 18, tracks the locations of the splices along the buffering line, and a thermoplastic buffer tube 20 (FIG. 1) is extruded about the bridging path 11 defining a transition buffer tube 20 (FIG. 1). A post-buffering marking device then marks buffer tube 20 with a suitable marking, for example, a marking M1 or M2 formed by ink or an indent marker. Thus markings M1 and M2 are made on transition buffer tube 20.

The tubes are then stranded together in a stranding operation, and another splice area mark can be applied to the stranded tubes or cable core, tape or other component. Next, the stranded buffer tubes are taken up on a reel, disk, or other suitable container. During a jacketing step, transition buffer tube 20 and the tubes stranded therewith in the core are paid off in a jacketing line and cable jacket 24 is extruded thereover. A marking system associated with the jacketing line reads and tracks the location of the splice area markings and makes a splice area mark on cable jacket 24 with, for example, an indent printer, laser or ink printer, or other suitable marking device. Exemplary splice area marks include “S1” and “S2” on cable jacket 24. Symbols other than alpha-numeric characters may be used as well. Any other portions of cable jacket 24 can be marked for a craftsman to locate bridging path 11, for example, a median portion Sm can be marked anywhere between splices S1 and S2 for locating the splice areas.

The bridging path 11 is integrated in fiber optic cable 10, and the bridging path, including the optical fibers and bridge optical fiber, preferably describe a helical or SZ stranded component within the cable. In other words, the bridging path is fully integrated in, protected by and locatable in, the fiber optic cable structure without a requirement for splice equipment, trays, or boxes. In one embodiment, splice areas are not associated with splice trays, boxes, enclosures, reels, and/or cross-over connectors in the cable. Integrating the bridge path in the fiber optic cable eliminates the need for hardware. The present invention has thus been described with reference to the foregoing embodiments, which embodiments are intended to be illustrative of the inventive concept rather than limiting. Persons of skill in the art will appreciate that variations and modifications of the foregoing embodiments may be made without departing from the scope of the appended claims. For example, fiber optic cables according to the present inventions can include such fiber types as single-mode, LEAF®, and/or METROCOR™, or other non-zero dispersion shifted fiber. Fiber optic cables of the present inventions can include tapes, water-blocking components, armor, a central anti-buckling member, buffer tube filling compounds, core binders, and/or other cable components, for example, as disclosed in U.S. Pat. Nos. 5,930,431, 5,970,196, or 6,014,487, which are respectively incorporated by reference herein. The concepts of the present invention can be applied to many cable systems and components, for example, tight buffered, single tube, optical ribbon, aerial, slotted core, and other cable designs and components. Further, the concepts of the present invention can applied to define a series of bridging paths spanning a few or many kilometers of cable length, over short or long haul distances.

Accordingly, what is claimed is:

1. A fiber optic cable for use in a DMCS, comprising:
at least one bridging path having, in optical communication, first and second optical fibers and a bridge optical fiber, a mode field diameter differential existing between said first and second optical fibers, and said first and second optical fibers having predetermined chromatic dispersion characteristics such that the range of the absolute values of the chromatic dispersion of said optical fibers is about ten to about forty ps/nm.km; and
said bridge optical fiber being integral with said cable and spliced to each of said first and second optical fibers thereby bridging said mode field diameter differential.

2. The fiber optic cable according to claim 1, said bridge optical fiber comprising a MFD along a portion of its length, at least portions of said MFDs of said first and second optical fibers being different from said MFD of at said portion of said bridge optical fiber.

3. The fiber optic cable of claim 1, said bridge optical fiber being fusion spliced to said first and second optical fibers.

4. The fiber optic cable of claim 1, said MFD differential being defined by said first optical fiber MFD being larger than the MFD of said second optical fiber.

5. The fiber optic cable of claim 1, the MFD of at least a portion of said bridge fiber being larger that the MFD of one of said first and second optical fibers and less than the MFD of other of said first and second optical fibers.

6. The fiber optic cable of claim 1, said bridge fiber having a generally constant MFD.

7. A fiber optic cable for use in a DMCS, comprising:
at least one bridging path having first and second optical fibers and a bridge optical fiber, said first and second optical fibers having predetermined chromatic dispersion characteristics such that the range of the absolute values of the chromatic dispersion of said first and second optical fibers is about ten to about forty ps/nm.km;
said bridge optical fiber being integrated in said cable and spliced to each of said first and second optical fibers defining splice areas, said fiber optic cable comprising at least one marking generally indicating the location of the splice areas or bridge optical fiber.

8. The fiber optic cable of claim 7, said at least one marking being made on said bridge optical fiber.

9. The fiber optic cable of claim 7, said bridging path being disposed in a buffer tube, said marking being located on said buffer tube.

10. The fiber optic cable of claim 7, said at least one bridging path being disposed within a cable jacket, said marking being located on said cable jacket.

11. The fiber optic cable of claim 7, said at least one bridging path being contained within said fiber optic cable, and said bridging path describing a helically or SZ stranded component within said fiber optic cable.

12. The fiber optic cable of claim 7, said fiber optic cable excluding splice trays, boxes, and enclosures.
